(19) United States
(12) Patent Application Publication
(10) Pub. No.: US 2015/0202898 A1
(43) Pub. Date: Jul. 23, 2015

(54) PRINTER APPARATUS

(71) Applicant: TOSHIBA TEC KABUSHIKI KAISHA, Tokyo (JP)

(72) Inventors: Kiyotaka Nihashi, Shizuoka-ken (JP); Tsuyoshi Sanada, Shizuoka-ken (JP)

(73) Assignee: TOSHIBA TEC KABUSHIKI KAISHA, Tokyo (JP)

(21) Appl. No.: 14/159,627

(22) Filed: Jan. 21, 2014

(51) Int. Cl. B41J 11/04

(52) U.S. Cl. CPC B41J 11/04

(57) ABSTRACT

A printer apparatus comprises a paper conveyance path configured to pull out and convey rolled paper, a printing section configured to print on the paper, a roller configured to contact with the outer peripheral surface of the paper and rotate the paper, and a roller rotation detection section configured to be arranged in a manner of clamping a shaft of the roller to detect the rotation of the roller by detecting a detection light passing through a through hole arranged on the shaft of the roller.

### FIELD

Embodiments described herein relate to a printer apparatus which prints on paper and issues the paper.

### BACKGROUND

In a printer apparatus used as an apparatus for issuing, for example, a receipt, after given items are printed on long-sized paper pulled from roll-shaped paper, the printed paper is cut into a given length and then discharged. In such a printer apparatus, the conveyed paper is sometimes jammed in a conveyance path. Thus, a detector such as a paper jam sensor is arranged in the printer apparatus.

In a printer using cut paper, when conveying a normal paper, a paper jam detection sensor alternately detects the existence and inexistence of paper at an interval of time taken to convey the length of paper in the paper conveyance direction, thus, it is easy to detect a paper jam. However, in a printer which prints on paper rolled into a roll shape, a paper jam sensor detects paper no matter whether the printer is standby, carrying out a printing job or completes a printing job. Consequentially, a space section, into which rolled paper enters, is arranged in a conveyance path to detect a paper jam.

However, there also exists a case where the rolled paper is rolled into a platen and the like for paper conveyance instead of entering the arranged space section. In this case, the printer apparatus determines that no paper jam occurs as the paper does not enter the space arranged.

Thus, as methods for detecting a paper jam in a paper conveyance state, a method is known in which a mark (so called as black mark) is arranged on the back side of paper, and a paper jam is detected by detecting the black mark with a sensor.

### BRIEF DESCRIPTION OF THE DRAWINGS

FIG. 1 is a diagram illustrating a main portion constitution of a printer apparatus according to an embodiment described herein;

FIG. 2 is an illustration diagram illustrating a detection position of a near-end sensor section of a printer apparatus according to the embodiment;

FIG. 3 is a block diagram illustrating a constitution of a control circuit of a printer apparatus according to the embodiment;

FIG. 4 is a flowchart illustrating a paper jam detection timing of a printer apparatus according to the embodiment;

FIG. 5 is a diagram illustrating a main portion constitution of a conveyance roller section of a printer apparatus according to the embodiment; and

FIG. 6 is a diagram illustrating a main portion constitution of a roller rotation detection section of a printer apparatus according to the embodiment.

### DETAILED DESCRIPTION

A printer apparatus comprises a paper conveyance path configured to pull out and convey rolled paper, a printing section configured to print on the paper, a roller configured to contact with the outer peripheral surface of the paper and rotate the paper, and a roller rotation detection section configured to be arranged in a manner of clamping a shaft of the roller to detect the rotation of the roller by detecting a detection light passing through a through hole arranged on the shaft of the roller.

The printer apparatus according to the present embodiment is described in detail below with reference to accompanying drawings.

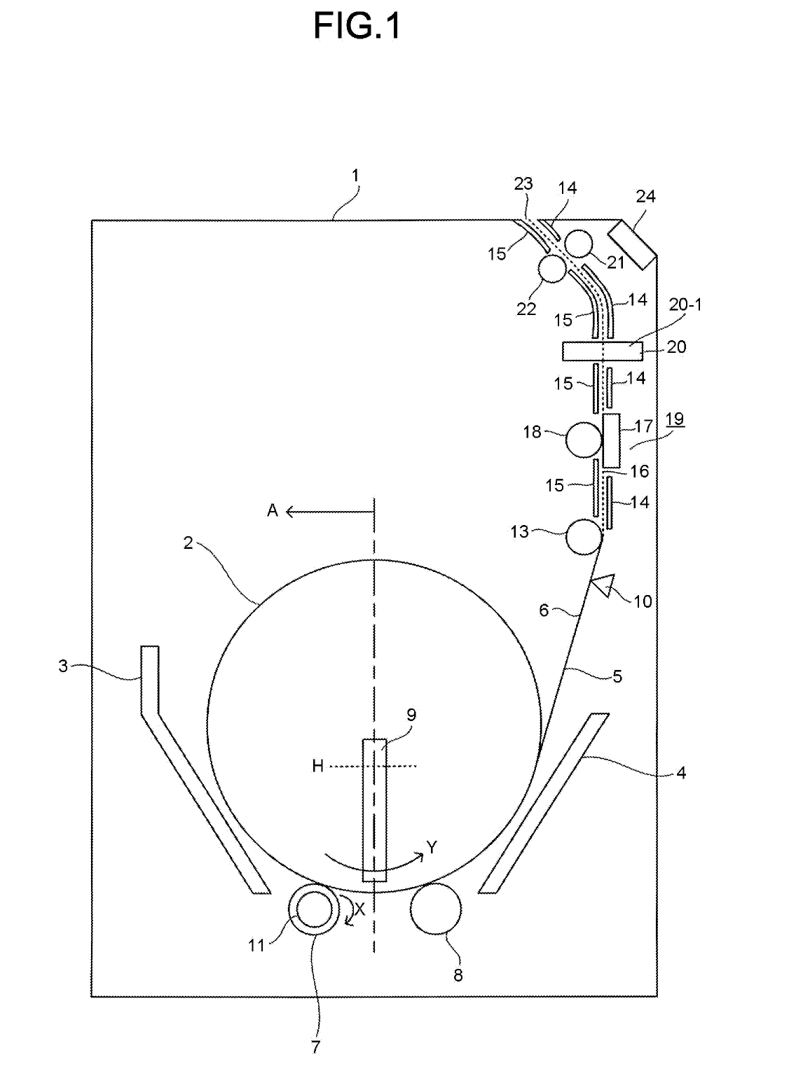

FIG. 1 is a constitution diagram illustrating main portions of a printer apparatus 1 according to the embodiment. Further, in the printer, as paper is conveyed from the lower side shown in FIG. 1 to the upper side shown in FIG. 1, the lower side shown in FIG. 1 is referred to as an upstream side and the upper side shown in FIG. 1 is referred to as a downstream side in the following description.

The reference sign 2 shown in FIG. 1 represents paper rolled into a roll shape. Paper 2 is loaded into the printer apparatus 1 from above after a printer cover (not shown) of the printer apparatus 1 is opened.

When the paper 2 is loaded, the loading position of the paper 2 is regulated by a paper guide A3 and a paper guide B4 such that the paper 2 is loaded in a state of contacting with a conveyance roller 7 and a delivery roller 8 having no drive force.

The paper 2 has a first paper surface 5 and a second paper surface 6 opposite to the first paper surface 5, wherein a thermosensitive layer which generates a color when heated is merely set on the first paper surface 5.

An idler roller 13 is rotationally supported at the downstream side of the delivery roller 8.

Further, a conveyance guide A14 and a conveyance guide B15 are arranged to extend from the idler roller 13 of the printer apparatus 1 to the downstream side of the printer apparatus 1, and the paper 2 is conveyed in the space between the conveyance guide A14 and the conveyance guide B15 which serves as a paper conveyance path 16.

At the downstream side of the idler roller 13, a thermal print head 17 and a platen roller 18 which can be rotated by a motor (not shown) are arranged opposite to each other across the paper conveyance path 16, and the thermal print head 17 and the platen roller 18 constitutes a printing section 19 which carries out printing operation on the first paper surface 5 of the paper 2.

A cutter 20 is arranged at the downstream side of the printing section 19. The cutter 20 has a fixed blade (not shown) and a movable blade (not shown) which slides towards the fixed blade under the drive of a cutter motor (not shown) to cut the paper 2 inserted in the slit (not shown) of the cutter 20.

Herein, the cutter 20 is the so-called sliding type cutter having a movable blade sliding towards a fixed blade, however, the present invention is not limited to this, and the cutter 20 may also be the so-called rotary type cutter having a movable blade rotating towards a fixed blade so as to cut the paper. Further, a cutter home position sensor 20-1 which will be described later is arranged in the cutter 20.

At the downstream side of the cutter 20, a discharging roller 21 which can be rotated by a motor (not shown) and a discharging idler roller 22 are arranged opposite to each other across the paper conveyance path 16. At the downstream side of the discharging roller 21, the printer apparatus 1 has a paper discharging port 23 from which the paper 2 which is subjected to printing processing and is cut by the cutter 20 is discharged to the outside of the printer apparatus 1 through the cooperation of the discharging roller 21 with the discharging idler roller 22.

Further, the printer apparatus 1 has a display section 24 for displaying various states including error state of the printer apparatus 1.

Further, a near-end sensor 9, a paper sensor 10 and a conveyance motor 11 are arranged in the printer apparatus 1, and a gear (not shown) arranged in the conveyance motor 11 meshes with a gear (not shown) arranged at one end of the conveyance roller 7.

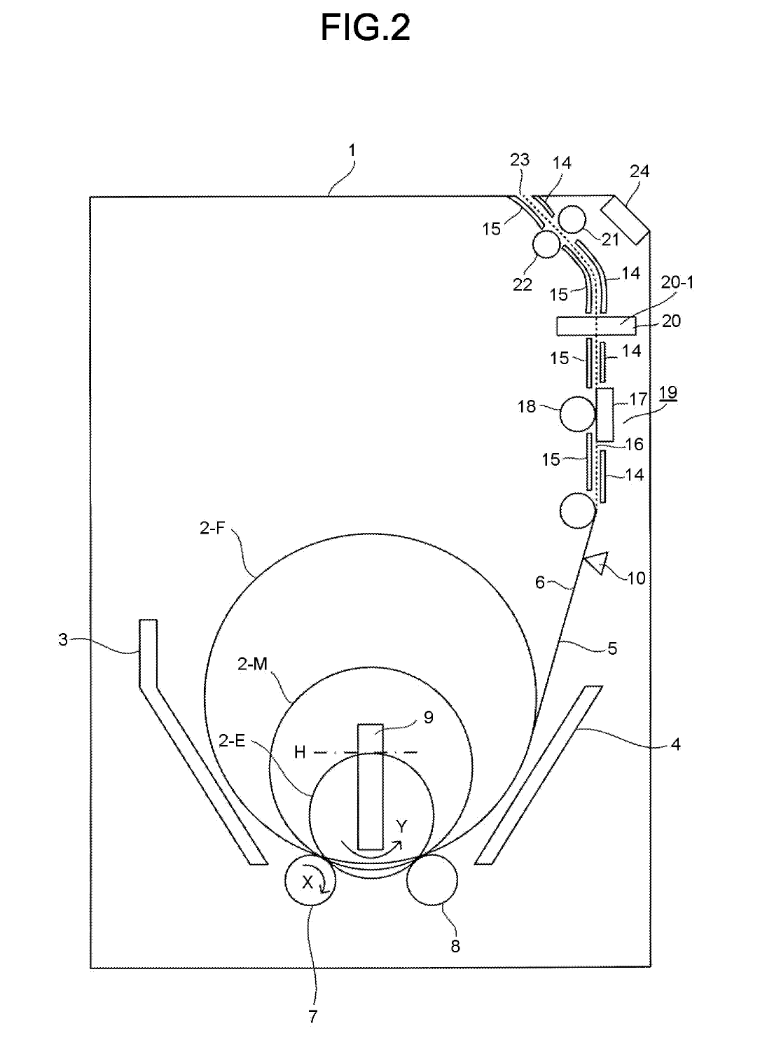

Next, detection methods of the near-end sensor 9 and the paper sensor 10 are described below with reference to FIG. 2.

The near-end sensor 9 is fixedly arranged on the frame (not shown) of the printer apparatus 1. The near-end sensor 9 comprises a light emitting section (not shown) and a light receiving section (not shown) which detects a detection light (not shown) that is emitted from the light emitting section and has a height of H. Further, roll-shaped paper 2 exists between the light emitting section and the light receiving section.

When the detection light emitted from the light emitting section goes towards the light receiving section, in a case where the roll-shaped paper 2 exists between the light emitting section and the light receiving section, the detection light is blocked. As a consequence, whether or not a roll diameter becomes smaller than a predetermined value can be determined. For example, in a case where the diameter of the roll-shaped paper 2 is the size when the paper 2 is loaded, that is, 2-F, or in a case where the paper 2 is used and the diameter of the roll-shaped paper 2 is reduced by half, that is, becomes 2-M, the detection light emitted from the light emitting section is blocked and cannot reach the light receiving section due to the existence of the paper 2 between the light emitting section and the light receiving section. Thus, no light receiving signal is sent from the light receiving section.

However, in a case where the paper 2 is used and the diameter of the roll-shaped paper 2 becomes a quarter of the initial diameter, that is, becomes 2-E, the paper 2 does not exist between the light emitting section and the light receiving section, therefore, the detection light emitted from the light emitting section reaches the light receiving section. Thus, a light receiving signal is sent from the light receiving section.

In this way, the near-end sensor 9 can detect that the residual quantity of the paper 2 is less than a predetermined quantity.

The paper sensor 10, which, different from the aforementioned near-end sensor 9, detects that the paper 2 is used up, is also arranged in the printer apparatus 1.

The paper sensor 10 is a reflection type sensor having a light emitting section (not shown) and a light receiving section (not shown), and in a case where the paper 2 exists, the detection light emitted from the light emitting section is reflected by the paper 2 into the light receiving section. In this way, the paper sensor 10 detects that the paper 2 exists. However, when the paper 2 is used up or no paper is loaded in the printer apparatus 1, the detection light emitted from the light emitting section is not reflected by the paper 2 and is therefore not transmitted to the light receiving section. In this way, the paper sensor 10 detects that the paper in the printer apparatus 1 is used up. Further, the paper sensor 10, although described as a reflection type sensor in the present embodiment, may also be a transmission type sensor having a light emitting section and a light receiving section which are arranged across the paper 2.

Further, a cutter home position sensor 20-1 is arranged in the cutter 20. The cutter 20 has a fixed blade (not shown) and a movable blade (not shown) which is moved towards the fixed blade under the drive of a motor (not shown) to cut the paper 2. A home position, at which the movable blade is positioned before the start and after the end of a cutting operation, is set in the cutter 20. The cutter home position sensor 20-1 detects whether or not the movable blade of the cutter 20 is at a position different from the home position due to an error cutting or a paper jam.

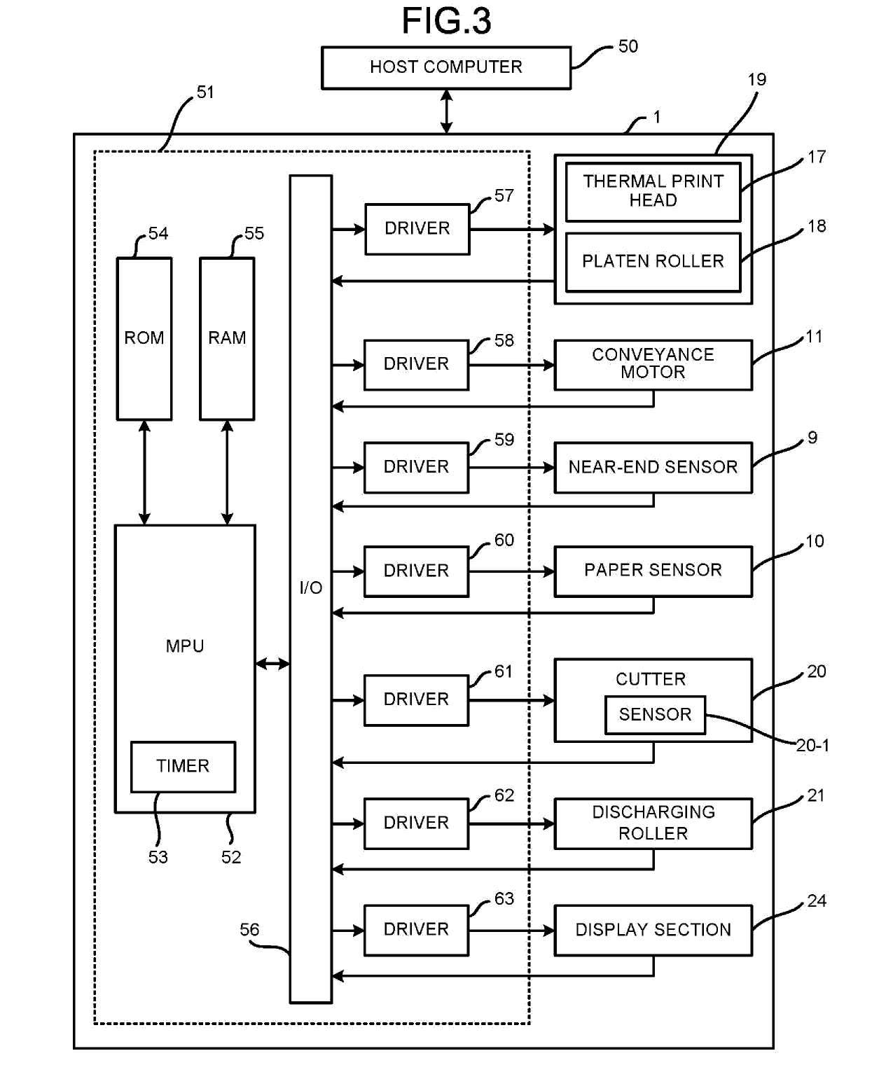

FIG. 3 is a block diagram illustrating a constitution of a control circuit of the printer apparatus 1 according to the present embodiment. A control section 51 controls the detection on the residual quantity of paper, the detection on the running out of paper, the paper conveyance, printing, paper cutting, paper discharging and the display of the condition of the printer.

The control section 51 is configured by, for example, a microcomputer which associates with a host computer 50 and carries out various controls. A micro processor unit (MPU) 52 of the control section 51 carries out, according to a program, various controls and operations such as the detection on the residual quantity of paper, the detection on the running out of paper, a paper conveyance control, a printing control, a paper cutting control and a paper discharging control.

Further, the MPU 52 comprises a timer 53 serving as a unit for setting and controlling time.

Further, a ROM 54 and a RAM 55 are arranged in the control section 51 as primary storage units for storing the control programs executed by the MPU 52 and the data generated during a control or operation process.

The ROM 54 is a read-only memory in which control programs and tables are stored, and the RAM 55 is a random access memory for storing the data generated during an operation process.

Further, an input/output unit (I/O) 56 is arranged in the control section 51 to read various input data from the host computer 50 and extract a control output of the control section 51 to the host computer 50. The I/O 56 is connected with the MPU 52, the ROM 54 and the RAM 55 via a bus line.

The I/O 56 is connected with a first, a second, a third, a fourth, a fifth, a sixth and a seventh driver 57, 58, 59, 60, 61, 62 and 63 serving as units for extracting a control output.

The first driver 57 supplies a required drive output for the printing section 19. The second driver 58 supplies a required drive output for the conveyance motor 11. The third driver 59 supplies a required drive output for the near-end sensor 9. The fourth driver 60 supplies a drive output for the paper sensor 10. The fifth driver 61 supplies a drive output for the cutter home position sensor 20-1 while supplying a drive output for the cutter 20. The sixth driver 62 supplies a drive output for the discharging roller 21. The seventh driver 63 supplies a display drive output for the display section 24 to enable the display section 24 to execute various displays.

When the MPU 52 of the control section 51 carries out printing on the paper 2 using the printing section 19 through the driver 57, the platen roller 18 is rotationally driven by a motor in synchronization with the printing operation based on a control output of a printing instruction unit of the MPU 52. The thermal print head 17 generates heat and prints on the first paper surface 5 of the paper 2 based on the printing data from the host computer 50.

The MPU 52 of the control section 51 rotates the conveyance motor 11 and stops the rotation of the conveyance motor 11 with the driver 58.

The MPU 52 of the control section 51 drives, with the driver 59, the near-end sensor 9 and receives a detection result

The MPU 52 of the control section 51 drives, with the driver 60, the paper sensor 10 and receives a detection result

The MPU 52 of the control section 51 receives a result of detection on whether or not the cutter blade is at the cutter home position while driving the cutter 20 with the driver 61 to cut the paper 2.

The MPU 52 of the control section 51 rotates the discharging roller 21 and stops the rotation of the discharging roller 21 with the driver 62.

The MPU 52 of the control section 51 displays various information and errors of the printer apparatus 1 on the display section 24 under the drive of the driver 63.

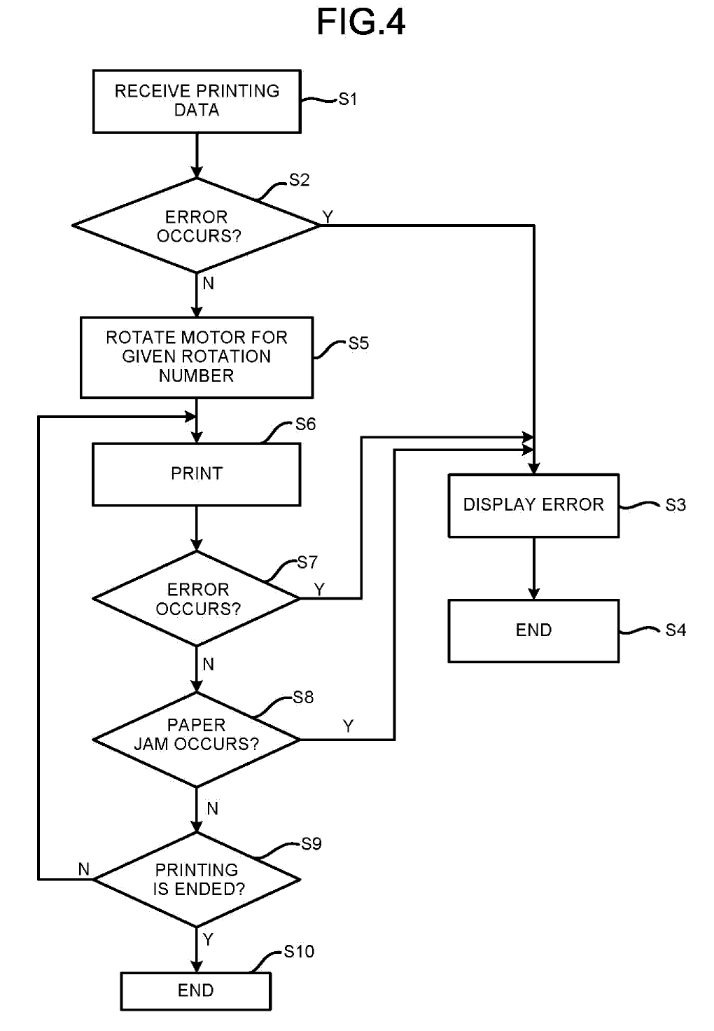

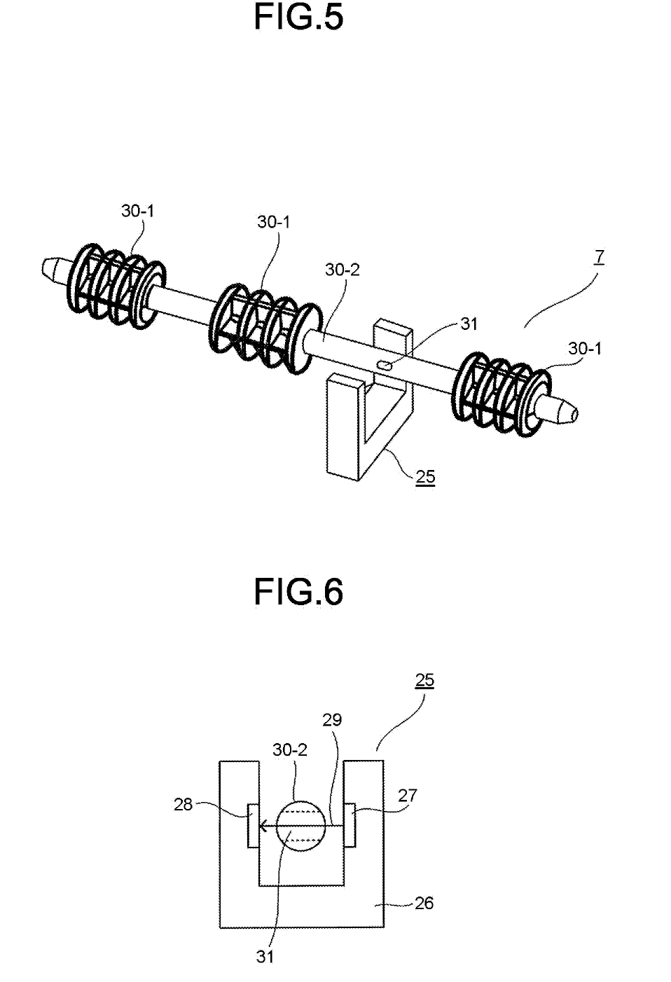

Next, the operations of the printer apparatus 1 are described below with reference to FIG. 1, FIG. 2, FIG. 4, FIG. 5 and FIG. 6.

First, the operator opens a printer cover (not shown) arranged in the printer apparatus 1 to load the paper 2 rolled into a roll shape into the printer apparatus 1 from above. When the paper 2 is loaded, the loading position of the paper 2 is regulated by the paper guide A3 and the paper guide B4 such that the paper 2 is loaded in a state of contacting with the conveyance roller 7 and the delivery roller 8.

Next, the operator pulls out the paper 2 and positions the front end of the paper 2 between the thermal print head 17 and the platen roller 18 via the idler roller 13.

In this state, if the printing data is received from the host computer 50 (ACT S1), the control section 51 checks whether or not an error occurs in the printer apparatus 1 (ACT S2). The error refers to, in the present embodiment, paper running out information based on the paper sensor 10 and the information indicating that the movable blade of the cutter 20 is not at the home position based on the cutter home position sensor 20-1. Further, to prevent that the printing operation is stopped due to the running out of paper during the printing process, the near end detected by the near-end sensor 9, instead of the information indicating that the paper is all used up, is sometimes used as the paper running out information. In this case, the near end detection of the near-end sensor 9 is considered as an error.

When an error occurs (YES in ACT S2), the content of the current error such as paper running out is displayed on the display section 24 of the printer apparatus 1 (ACT S3), and then the printer apparatus 1 ends the printing operation (ACT S4).

When no error occurs in the printer apparatus 1 (NO in ACT S2), the control section 51 rotates the conveyance motor 11 to rotate the conveyance roller 7 connected with the conveyance motor 11 for a given rotation number in the X direction shown in FIG. 1 (ACT S5). The surface of the conveyance roller 7 is made from rubber and the like, and is contacted with the surface of the roll-shaped paper 2. Thus, when the conveyance roller 7 is rotated in the X direction, the roll-shaped paper 2 contacted with the conveyance roller 7 is rotated in the Y direction shown in FIG. 1 through the friction with the conveyance roller 7. Further, the platen roller 18 of the printing section 19 is rotated in synchronization with the rotation of the paper 2. In this way, the paper 2 is conveyed by the conveyance roller 7 and the cooperation of the thermal print head 17 with the platen roller 18. Further, the given rotation number, which is mastered in advance, is a setting value by which a stationary rotation is achieved if the conveyance motor 11 is rotated for the given rotation number, and moreover, in a case where the conveyance motor 11 is a stepping motor, the given rotation number is given steps the conveyance motor 11 is rotated.

The conveyance motor 11, after being rotated for the given rotation number (ACT S5), enters a stationary rotation state, that is, the roll-shaped paper 2 rotated through the friction with the conveyance roller 7 is conveyed at a stationary speed, and then the control section 51 drives the printing section 19 to print on the paper 2 (ACT S6).

Sequentially, the control section 51 periodically checks whether or not an error occurs in the printer apparatus 1 during the printing process (ACT S7). The error, which is the same as the checked error mentioned above, refers to paper running out information based on the paper sensor 10 and the information indicating that the movable blade of the cutter 20 is not at the home position based on the cutter home position sensor 20-1.

If an error occurs (YES in ACT S7), the content of the current error such as paper running out is displayed on the display section 24 of the printer apparatus 1 (ACT S3), and then the printer apparatus 1 ends the printing operation (ACT S4). If no error occurs (NO in ACT S7), the control section 51 checks whether or not a paper jam occurs in the printer apparatus 1 (ACT S8).

A paper jam detection section for detecting whether or not a paper jam occurs in the printer apparatus 1 is described below with reference to FIG. 5 and FIG. 6.

The conveyance roller 7 has a contact roller 30-1 and a shaft 30-2, and a substantially concave sensor block 26 is arranged to surround the shaft 30-2 from lateral sides and a lower side. A light emitting section 27 is arranged on the internal surface of the sensor block 26 at the side of the shaft 30-2, and a light receiving section 28 is arranged on an internal surface opposite to the light emitting section 27.

It is arranged that a detection light 29 emitted from the light emitting section 27 enters the light receiving section 28, and the shaft 30-2 of the conveyance roller 7 is located between the light emitting section 27 and the light receiving section 28. A through hole 31 is arranged on the shaft 30-2 at the path of the detection light 29 from the light emitting section 27 to the light receiving section 28. That is, the detection light 29 emitted from the light emitting section 27 passes through the through hole 31 when the shaft 30-2 is in the state shown in FIG. 6 and reaches the light receiving section 28, however, when the shaft 30-2 is not rotated to the position shown in FIG. 6, the detection light 29 is blocked by the shaft 30-2 and cannot reach the light receiving section 28.

The sensor block 26, the light emitting section 27, the light receiving section 28 and the through hole 31 constitute a roller rotation detection section 25.

The control section 51 sends an instruction to instruct the light emitting section 27 to emit light all the time, and receives a signal sent from the light receiving section 28 when the detection light 29 is received.

The rotation number of the conveyance roller 7 in a stationary state is predetermined. When the conveyance roller 7 rotates in a stationary state, the light receiving section 28 sends a light receiving signal at an interval of the time taken by the shaft 30-2 to rotate for 180 degrees. The control section 51 can determine whether or not the conveyance roller 7 is rotated in a stationary state by confirming the signals. It is determined that the paper 2 is not conveyed correctly, that is, a paper jam occurs, if the conveyance roller 7 is not rotated in a stationary state.

However, the time interval at which light receiving signals are sent before the conveyance roller 7 enters a stationary state is longer than the interval of time taken by the shaft 30-2 to rotate for 180 degrees. Thus, in the present embodiment, the time interval at which light receiving signals are sent is confirmed after the conveyance motor 11 is rotated for the given rotation number and is supposed to enter a stationary rotation state. In this way, a more accurate detection on the occurrence of paper jam can be achieved.

If it is determined that a paper jam occurs in the printer apparatus 1 (YES in ACT S8), the occurrence of paper jam is displayed on the display section 24 of the printer apparatus 1 (ACT S3), and then the printer apparatus 1 ends the printing operation (ACT S4). The control section 51 checks whether or not the printing operation is ended (ACT S9) if there is no paper jam (NO in ACT S8). The printing based on the printer apparatus 1 is ended (ACT S10) if the printing operation is ended (YES in ACT S9). If the printing is not ended (NO in ACT S9), the check on an error (ACT S7) and the check on a paper jam (ACT S8) are continued until the printing is ended.

For example, in the printer apparatus 1 shown in FIG. 1, when an error detection mechanism consists merely of the near-end sensor 9, the paper sensor 10 and the cutter home position sensor 20-1, in a case where the paper 2 is rolled on the platen roller 18 and cannot be conveyed to the cutter 20 at the downstream side of a printing conveyance direction, the near-end sensor 9 and the paper sensor 10 carry out no error detection as long as there is residual paper 2, and the cutter home position sensor 20-1 carries out no error detection either. Thus, even if a paper jam occurs due to that the paper 2 is rolled on the platen roller 18, the paper jam cannot be recognized by the printer apparatus 1. Contrastively, according to the present embodiment, in the paper jam detection based on the confirmation of the rotation of the conveyance roller 7, the paper jam occurring at any position of the printer apparatus 1 can be detected.

Besides, the conveyance roller 7 is provided with a shaft 30-2 on which a through hole 31 is arranged, and the rotation of the shaft 30-2 is detected by detecting the detection light 29 passing through the through hole 31, thereby detecting the jam of the paper 2. The paper jam detection section is prevented from protruding towards the outside from the width range of the conveyance roller 7 by arranging the substantially concave sensor block 26 which surrounds the shaft 30-2 from lateral sides and a lower side. Thus, the printer apparatus 1 is prevented from getting oversized with a detection section which protrudes to the outside from the width range of the conveyance roller 7.

Further, there also exists a known technology in which a mark (so called as black mark) is arranged on the second paper surface 6 of the paper 2, and the occurrence of a paper jam is detected by detecting the black mark using a separately arranged black mark sensor. However, in this case, in addition to special paper provided with a black mark on the second paper surface 6 of the paper 2, a black mark sensor is also required.

Contrastively, neither special paper nor a sensor for detecting the special paper is needed in the present embodiment.

Further, it is preferred that the conveyance roller 7 is arranged at a position more upstream than a vertical line passing the center of the roll-shaped paper 2 in a paper conveyance direction, that is, in the direction A shown in FIG. 1.

As the paper 2 is only carried on the conveyance roller 7 and the delivery roller 8, the paper 2, if pulled out by the thermal print head 17 and the platen roller 18, is likely to move towards the direction A, that is, the upstream side of the vertical line passing the center of the roll-shaped paper 2 in the paper conveyance direction.

As shown in FIG. 1, the paper 2 will not separate easily from the conveyance roller 7 as long as the conveyance roller 7 is arranged in the movement direction A of the paper 2. However, if the conveyance roller 7 and the conveyance motor 11 are arranged at the position of the delivery roller 8 shown in FIG. 1, the paper 2 may separate from the conveyance roller 7 when the roll-shaped paper 2 is moved in the direction A. If the paper 2 separates from the conveyance roller 7, the light receiving signal for detecting the rotation of the conveyance roller 7 is influenced, thereby, a paper j am is detected mistakenly even no paper jam occurs. Thus, it is preferred that the conveyance motor 11 for driving the conveyance roller 7 is arranged at the upstream side of the vertical line passing the center of the roll-shaped paper 2 in the paper conveyance direction.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A printer apparatus, comprising:
a paper conveyance path configured to pull out and convey rolled paper;
a printing section configured to print on the paper;
a roller configured to contact with the outer peripheral surface of the paper and rotate the paper; and
a roller rotation detection section configured to be arrange in a manner of clamping a shaft of the roller to detect the rotation of the roller by detecting a detection light passing through a through hole arranged on the shaft of the roller.

2. The printer apparatus according to claim 1, wherein
the roller is arranged at the upstream side of a vertical line passing the center of the paper in a paper conveyance direction.

3. A printer apparatus, comprising:
a paper conveyance path configured to pull out and convey rolled paper;
a printing section configured to print on the paper;
a roller configured to transport the paper; and
a roller rotation detection section configured to be arrange in a manner of clamping a shaft of the roller to detect the rotation of the roller by detecting a detection light passing through a through hole arranged on the shaft of the roller.
